(19) United States
(12) Patent Application Publication
(10) Pub. No.: US 2007/0240027 A1
(43) Pub. Date: Oct. 11, 2007

(54) Forward Error Correction Decoders

(75) Inventors: Jussi Vesma, Turku (FI); Harri Pekonen, Raisio (FI)

Correspondence Address: HARRINGTON & SMITH, PC, 4 RESEARCH DRIVE, SHELTON, CT, 06484-6212, US

(73) Assignee: NOKIA CORPORATION, Espoo (FI)

(21) Appl. No.: 11/630,841

(22) PCT Filed: Mar. 18, 2005
(86) PCT No.: PCT/IB05/50950

§ 371 Date: Dec. 21, 2006

(30) Foreign Application Priority Data
Jun. 30, 2004 (GB) 0414667.6

(51) Int. Cl. H04L 1/00

(52) U.S. Cl. 714/759

(57) ABSTRACT

An erasure information table includes one element for each column of a data frame, stored in an IP datagram buffer and in an RS data buffer, instead of an element for each element of that column. Thus, CRC checking is performed against datagrams, instead of individual elements, of a received data frame, and effective error correction can be carried out by a Reed Solomon decoder. The effectiveness of the error correction is decreased since errors will be indicated as being present when actually an error is present in another row. The amount of memory needed to stare the erasure information though is reduced. In another embodiment, a linked list includes an element for each series of datagrams which have the same error status (i.e. reliable or unreliable). Each element includes the start address of the first datagram in that sequence and indicates the error status. Different lists may be used for application data and for parity data.

This invention relates to a method of operating a forward error correction decoder, and to a forward error correction decoder.

It is proposed to use MPE level Forward Error Correction (MPE-FEC) in the Terrestrial Digital Video Broadcasting (DVB-T) broadcast system and in an extension of it termed DVB-H (DVB handheld), also previously known as DVB-X. Forward error correction is convenient since it allows a receiver to correct errors in received digital data without requiring any data to be retransmitted. This is likely to be of particular importance when the receiver is included in a mobile terminal.

MPE-FEC is intended to be introduced to support reception in situations of high Packet Loss Ratio (PLR) on the MPE section level. Such high PLR may occur for example on mobile channels (when high Doppler frequencies can be experienced) when the speed is too high, when the carrier to noise ratio is too low and/or due to impulse noise.

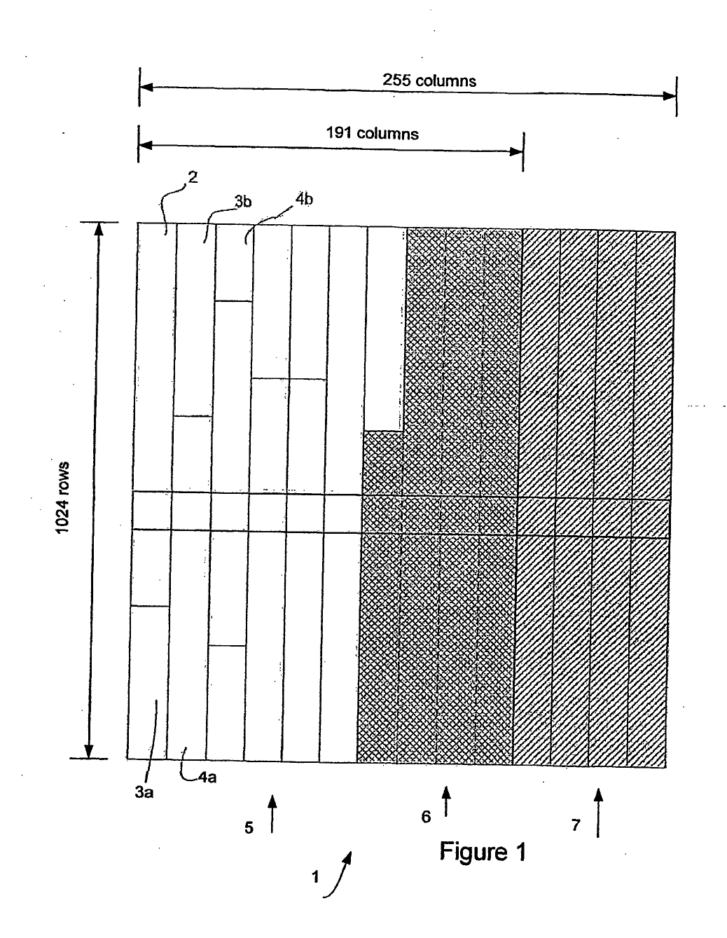

The MPE-FEC encoder in the transmitter side is usually placed in the IP encapsulator (IPE). The encapsulator stores data packets in a coding table or array, typically of a pre-determined size. Forward error correction data is then calculated for each row of the array, and this forms parity data. This data is then entered into a portion of the array referred to as the parity data section but can also be termed RS (Reed Solomon) data table. One example of this is illustrated in FIG. 1.

Referring to FIG. 1, an exemplary coding array 1 is illustrated comprising 1024 rows of elements by 255 columns of elements. Convention is that the maximum number of rows in this example is 1024, although there can be fewer rows. The number of rows is signalled in a time_slice_fec_indicator_descriptor field of a DVB broadcast. In other systems there may be more than 1024 rows. Each element of the array stores one byte of data. A first 191 columns of elements are comprised of application data 5 (shown unshaded) and zero padding 6 (shown cross-hatched).

The application data is made up of a number of datagrams, which are included sequentially in the table starting at the top left-hand corner and then filling up the columns in turn. In this example, a first datagram 2 is followed by a second datagram, which includes a portion 3a included in a first column, and a second portion 3b included in a second column. Similarly, a third datagram comprises a portion 4a in the second column and another portion 4b in a third column. Once all of the required datagrams have been included in the coding array, the elements which remain in the 191 columns and which have not been included with application data are zero padded, i.e. they are filled with zeros. Following the filling of the first 191 columns with application data and zero padding, the parity data is calculated.

An exemplary way to prepare the parity data is using the Reed Solomon algorithm. This is calculated for each of the 1024 rows. For each of the 191 elements of application data and zero padding in a row, 64 elements of Reed Solomon parity data are generated and are included at the end of that row. Repeating this procedure for each of the 1024 rows result in the coding array 1 being completed with either application data elements, zero padding or parity data elements. Thus, using MPE-FEC, about 25% of TS (Transport Stream) data is allocated to parity overhead. The parity data section is indicated at 7 (showns with parallel line shading). The application datagrams are encapsulated in MPE sections and each column of RS parity data is encapsulated in a single respective, MPE-FEC section. Further, MPE and MPE-FEC sections are divided into the transport stream (TS) packets for transmission. The starting address of each datagram in the table is signalled to the receiver. This allows the coding array 1 to be reproduced easily at a receiver. The zero padding is not usually transmitted.

In the example of FIG. 1, the number of rows and columns is shown consolidated for ease of illustration.

The above described FEC procedure is referred to as RS (255,191), denoting Reed Solomon 255 columns, 191 of which are application data and zero padding. The Reed Solomon FEC procedure can correct errors in 32 of the elements in a row. If erasure information is used, errors can be corrected in 64 elements in a row.

Erasure information identifies which elements in the coding array 1 reproduced at a receiver have errors in them. Thus, an erasure information table can be produced having 1024 rows by 255 columns. There will be as many rows in the erasure information table as there are rows in the coding array 1. Although the coding array 1 has one byte of data in each element, the corresponding elements in the erasure information table includes only one bit. In this example, an element in the erasure information table is a ‘zero’ if the corresponding element is correct or a ‘one’ if the corresponding element is incorrect. Information needed to determine whether the data in a received element is correct or incorrect can be obtained from a Cyclic Redundancy Check (CRC) for Internet Protocol (IP) datagrams, or for MPE sections, or from the DVB-T Reed Solomon decoder for Transport Stream packets or from a combination of them. When determining whether or not an element is correct, the RS parity data 7 is treated equally to the application data elements 5. However, zero padding is always marked as correct when using erasure decoding if the location of the padding is known.

The Reed Solomon algorithm does not depend on the nature of the application data in the datagrams 2 to 4. Accordingly, this procedure is usable with multi-protocol encapsulation (MPE). This is seen to be particularly important with DVB-H, since the data may relate to audiovisual content, to audio content, or to file downloads amongst other things.

The MPE-FEC is introduced in such a way that an MPE-FEC ignorant (but MPE capable) DVB Receiver will be able to receive the MPE stream in a fully backwards-compatible way. This backwards compatibility holds both when the MPE-FEC is used with and without time slicing. The use of MPE-FEC is not mandatory. Its use is defined separately for each elementary stream in a TS. For each elementary stream it is possible to choose whether or not MPE-FEC is used, and if it is used, to choose the trade-off between FEC overhead and RF performance, in particular through puncturing and zero-padding. Time critical services, without MPE-FEC and therefore minimal delay, could therefore be together with less time critical services using MPE-FEC, on the same TS but on different elementary streams.

It has been proposed to identify which of the data included in the 191 columns in the coding array 1 is application data elements and which is zero padding through the use of two separate schemes. In a first proposed scheme, a one-bit field in time-slicing and FEC real-time parameters which is transmitted in the MPE or MPE-FEC header, is named as “table_boundary”. This field is set to “1” for the MPE section carrying the last IP datagram in the current MPE-FEC table. If a receiver finds an MPE section where the table_boundary flag is set to one, the receiver can determine the starting point of the zero padding (assuming that the CRC check indicates that the last MPE section is correct). The starting address of the IP datagrams is signalled in the MPE section header. Normally, the starting point of the zero padding can be calculated from the starting address and length of the last IP datagram.

Another proposal is to include an 8-bit field named “padding_columns” in an FEC section header. This field is proposed to indicate the number of columns that include only zero padding. If a column includes both application data and zero padding, the entire column is treated as application data.

A frame or coding array 1 having 1024 rows includes just over 2 Mbits of data, the storing of which can represent a significant burden on a mobile receiver. This burden is increased when MPE-FEC is used, since the parity data must be stored and since the erasure information table for such a coding array 1 comprises 255 kbits of data, and thus is one eighth the size of the coding array. It is an aim of the invention to reduce the amount of memory required to decode received data using forward error correction.

According to a first aspect of the invention there is provided a forward error correction decoder, comprising one or more processors arranged:
to receive a data frame comprising plural multibit data elements able to be arranged into a table of columns and rows of data elements, the data frame including application data elements and parity data elements;
to check the data in the data frame for errors; and
to generate erasure information for each of plural units of data, each unit of data containing plural data elements, the erasure information indicating whether or not all the elements in the unit of data are error-free.

Since erasure information is generated for a unit of data which is larger than the size of one data element, the amount of erasure information required for the entire data frame is less than in the prior art. This means that less memory is needed in a receiver to process the data frame, which is particularly significant where the receiver is a mobile receiver. This memory saving may be achieved in some implementations at the expense of a reduction in the error correction capabilities in a receiver, although this is considered to be unproblematic in most situations.

In the embodiments, the data elements are one byte each, although it will be appreciated that the invention can apply to other data element sizes. The data elements are those elements which are individually correctable by forward error correction, for example using a Reed Solomon decoder.

The decoder preferably is arranged to store the erasure information in an array. There may be a separate array for different portions of the data frame, in particular application data, parity data and, if present, padding data portions. Erasure information may not be stored for data units which include only padding data. Alternatively, a single array may be used for the erasure information of both application data and padding data portions of the data frame. Where erasure information is stored for padding data, this will usually indicate that the padding data is error-free

The decoder may be arranged to store the erasure information in a list of items, each item including an element address and an error indication, each item in the list identifying a boundary of a sequence of data units having the same error status.

Storing the erasure information as a list can make it easily useable yet compact in size. Each item in the list may identify a boundary of a sequence of data units having a different error status to each sequence which is adjacent the sequence. This can allow the list to be smaller, since the list includes an item only where there is a change in the error status from one sequence to the next. Whether or not adjacent sequences have different error statuses, the decoder may be arranged to store the erasure information in a first list for data units including application data, and a second list for data units including parity data.

If the data frame comprises plural datagrams each comprising plural elements, the decoder can be arranged to check whole datagrams for errors. This is particularly convenient where each datagram includes a cyclic redundancy check or other check, since the processing of this can present a significantly smaller burden on the resources of a receiver than the processing of a check on the error status of each element individually.

Advantageously, the decoder is arranged to generate erasure information indicating an error in a unit of data if the unit of data includes at least part of a datagram which is determined to include one or more errors. Thus, all errors can be identified in the erasure information, although some elements which do not contain errors also will tend to be marked as including an error. However, this allows all errors to be identified, thus preventing errors being overlooked.

Advantageously, each column of the data frame constitutes a single unit of data. This results in a single element of erasure information being generated for each column of data. Thus, a significantly reduced amount of memory will be needed to store the erasure information than if there was an element of erasure information for each element in the data frame. Moreover, the amount of erasure information does not vary with the number of rows in a data frame, simplifying memory allocation in a receiver.

The invention also provides a receiver, for example a digital video broadcasting receiver, including a forward error correction decoder as claimed in any preceding claim. The receiver preferably is included in a mobile terminal.

According to a second aspect of the invention, there is provided a method of operating a forward error correction decoder, the method comprising:
receiving a data frame comprising plural multibit data elements able to be arranged into a table of columns and rows of data elements, the data frame including application data elements and parity data elements;
checking the data in the data frame for errors; and
generating erasure information for each of plural units of data, each unit of data containing data plural elements, the erasure information indicating whether or not all the data elements in the unit of data are error-free.

Embodiments of the present invention will now be described, by way of example only, with reference to the accompanying drawings, of which:

FIG. 1 is a schematic drawing of an exemplary coding array used to illustrate operation of FEC decoders and receivers;

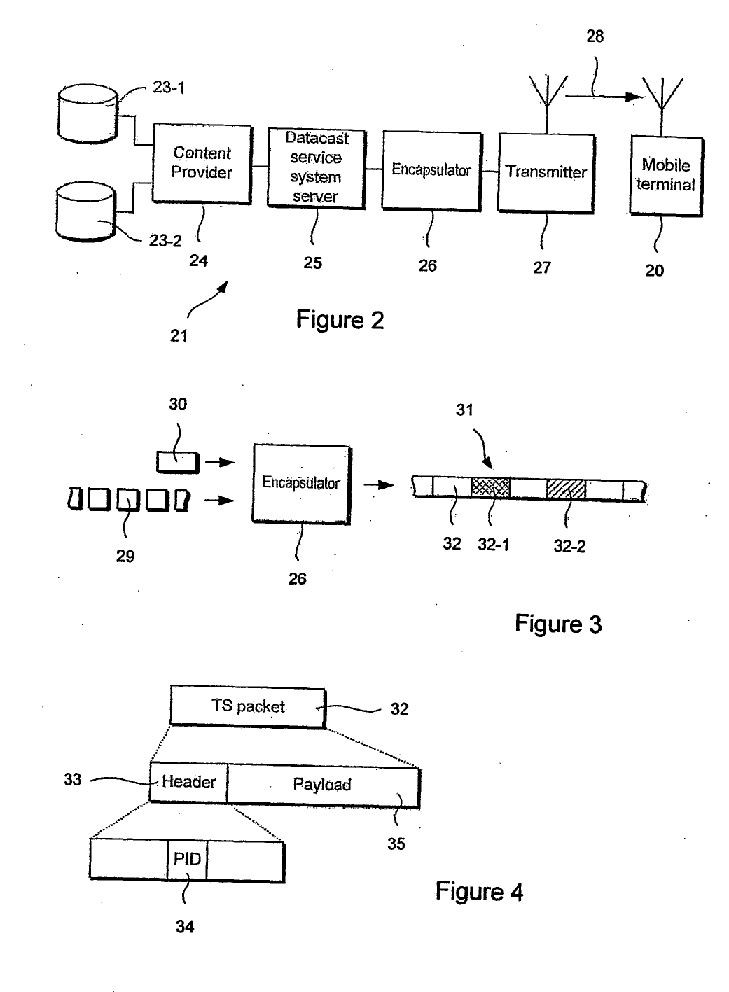

FIG. 2 shows an embodiment of a communication system in which the present invention may operate;

FIG. 3 shows an embodiment of a multiprotocol encapsulation (MPE) encapsulator forming part of the FIG. 2 system;

FIG. 4 illustrates an exemplary a transport stream packet.

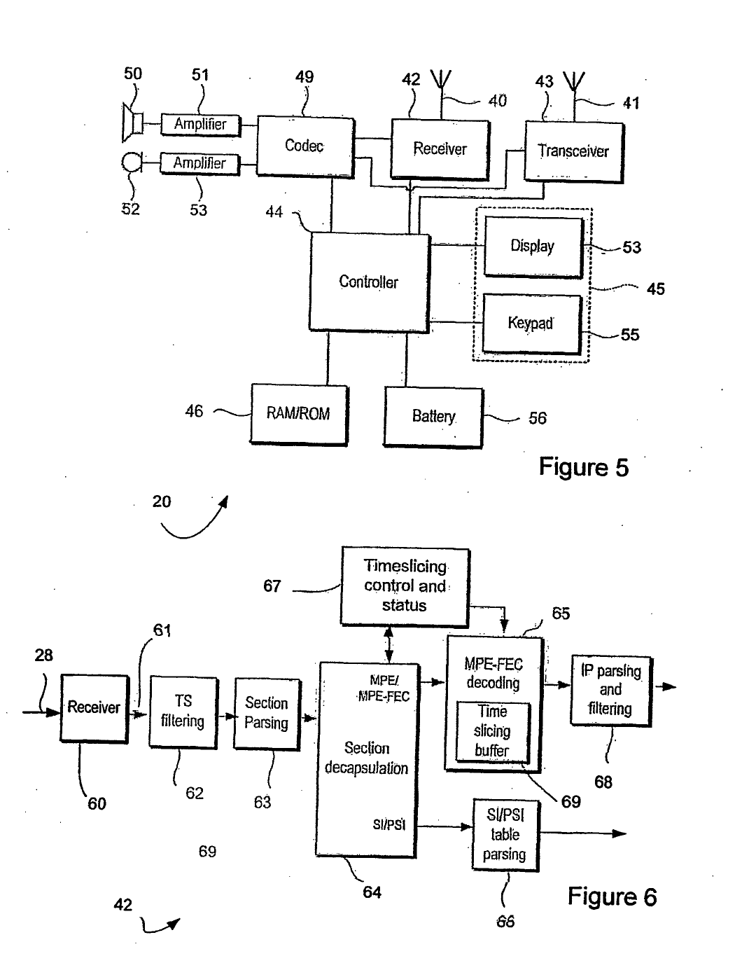

FIG. 5 illustrates schematically a mobile terminal included in the FIG. 1 system and implementing the invention;

FIG. 6 shows operation of certain parts of the FIG. 5 mobile terminal, including a decoder according to the invention;

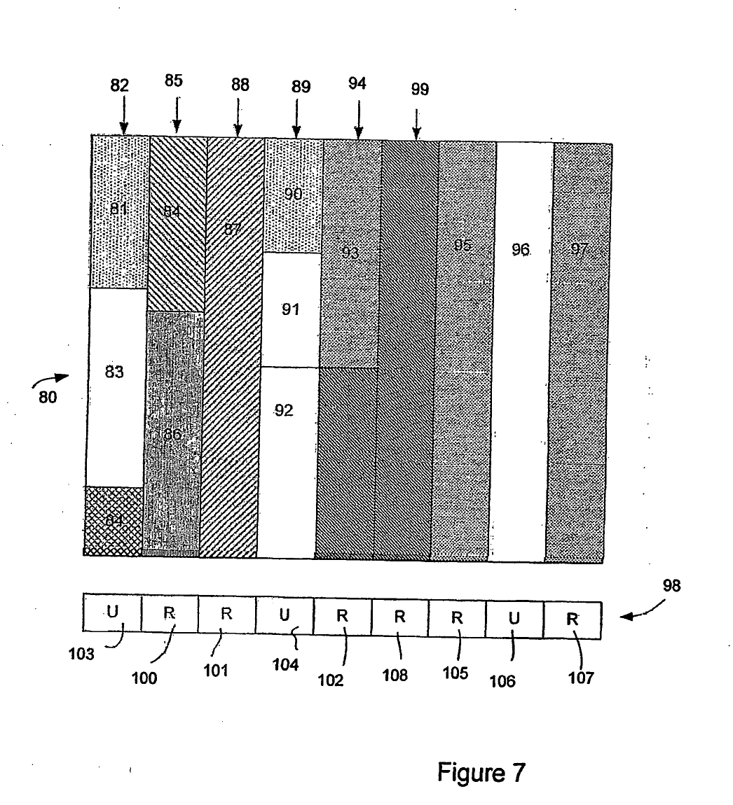

FIG. 7 is a schematic drawing of a coding array or data frame used to illustrate the invention;

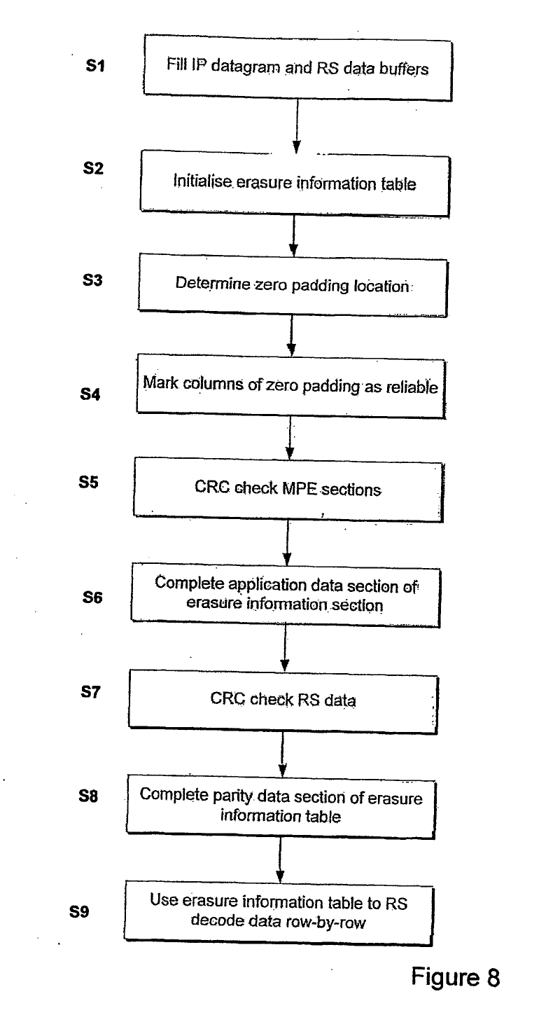

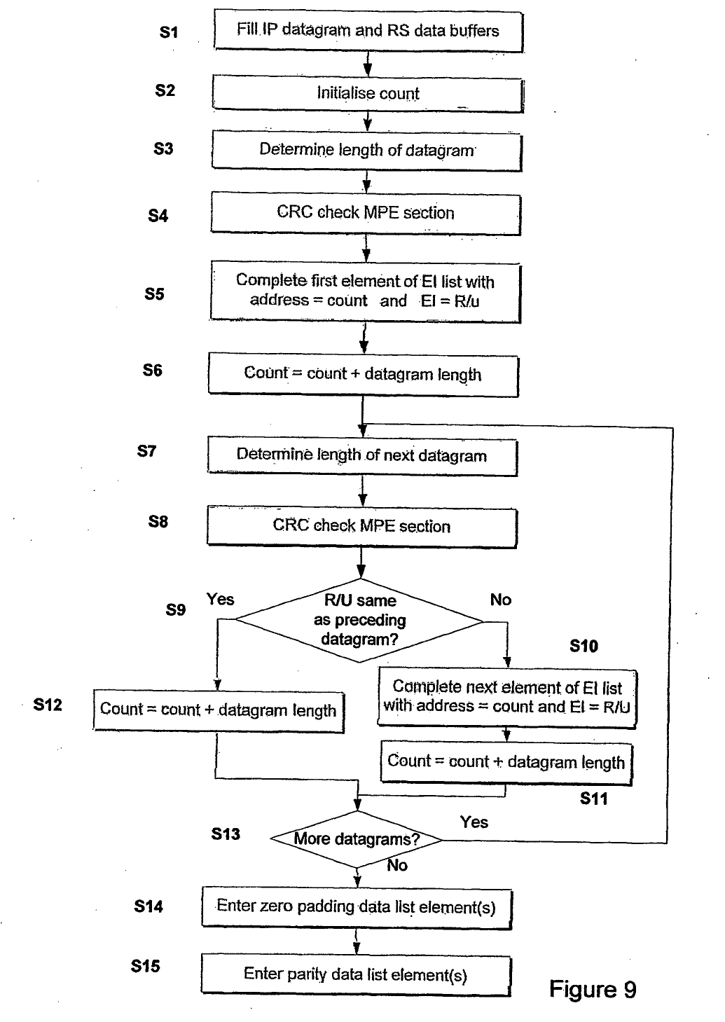

FIGS. 8 and 9 are flow charts illustrating decoder operation according to first and second embodiments of the invention respectively; and

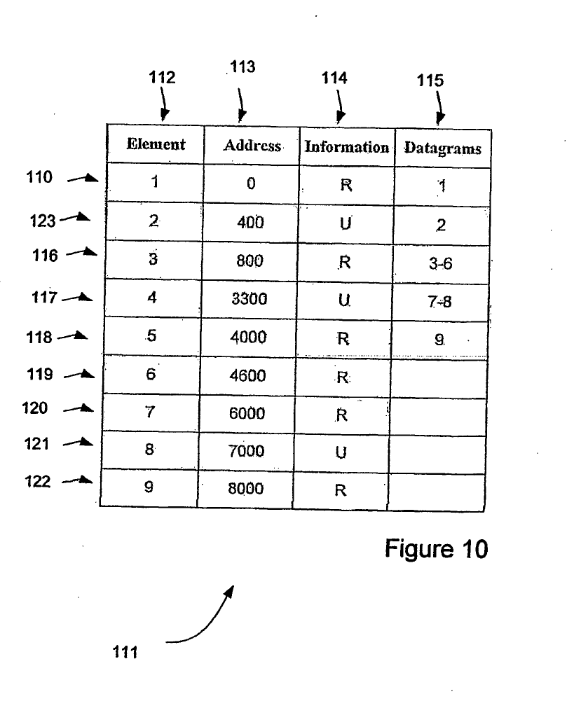

FIG. 10 is an erasure information table provided by the second embodied decoder.

Referring to FIG. 2, a communications network 21 for delivering content to a mobile terminal 20 is shown. The communications network 21 includes a terrestrial digital video broadcasting (DVB-T) or a DVB-H network, which is used as a broadcast access network to deliver content for an Internet Protocol Data Casting (IPDC) service. However, other digital broadcast networks may be used including other types of DVB networks, such as a cable DVB network (DVB-C) or satellite DVB (DVB-S) network, a Digital Audio Broadcasting (DAB) network, an Advanced Television System Committee (ATSC) network or an Integrated Services Digital Broadcasting (ISDB) network.

The communications network 21 includes sources 23-1, 23-2 of content, for example in the form of video, audio and data files, a content provider 24 for retrieving, re-formatting and storing content, a datacast service system server 25 for determining service composition, an Internet-protocol (IP) encapsulator (IPE) 26 and a transmitter 27 for modulating and broadcasting a signal 28 to receivers (not shown) including a mobile terminal 20.

Referring to FIG. 3, the IP encapsulator 26 receives one or more streams of data 29 and service data 30 and generates therefrom MPEG program specific information (PSI) and DVB service information (SI), for inclusion in a transport stream 31 comprising MPEG-2 transport stream (TS) packets 32, typically 188 bytes long, according to International Organisation for Standards/International Electrotechnical Commission (ISO/IEC) Standard 13818-1 “Information Technology-Generic Coding of Moving Pictures and Associated Audio Information: Systems”.

Referring to FIG. 4, the transport stream 31 is divided into a number of logical channels, referred to as “elementary streams”. The elementary stream to which a TS (transport stream) packet 32 belongs is defined in a packet header 33 using a packet identifier (PID) 34. The PID 34 is used to identify elementary streams. Certain PIDs are reserved for SI tables, and some are reserved for PSI tables. There is a range of PIDs to which MPE/MPE-FEC section streams can be put.

Accordingly, it can be determined from the PID 35 if the particular elementary stream contains a particular SI table or MPE section stream. Thus, the packet identifier 34 can be used to identify contents of a TS packet payload 35 in some cases.

For example, the contents of a first TS packet 32-1 may be identified as containing all or part of a network information table SI) by specifying PID=0x0010 (as a hexadecimal number). The contents of a further TS packet 32-2 may be identified as being video, audio or another type of data by specifying a PID value between 0x0030 to 0x1FFE (hexadecimal). A range of PIDs is allocated to MPE/MPE-FEC section streams.

Referring again to FIG. 2, the DVB transmitter 27 receives a signal from the encapsulator 26 which it modulates, amplifies and broadcasts.

Other network elements may be provided, such as a multiplexer (not shown) for combining a plurality of services (although an IPE can provide plural services), and a gap-filler transmitter for receiving and re-transmitting the signal 28. Furthermore, another communications network (not shown), such as a public land mobile network, preferably in the form a 2nd or 3rd generation mobile network such as GSM or UMTS respectively, may be provided for providing a return channel from the mobile terminal 20 to the communications network 21. A further communications network (not shown), such as the Internet, may be provided to connect distributed elements of the communications network 21, such as the content provider 24 and the service system server 25.

The IP encapsulator 26 generates forward error correction (FEC) data packets and assembles them into bursts comprising application data, and multiplexes transport stream packets into a single transport stream. The IP encapsulator may be implemented in software and/or hardware.

Referring to FIG. 5, one embodiment of the mobile terminal 20 is shown schematically in the form of a combined mobile telephone handset and DVB-H receiver.

The mobile terminal 20 includes first and second antennas 40, 41, a DVB-H receiver 42 and a mobile telephone transceiver 43. The receiver 42 and the transceiver 43 each include RF signal processing circuits (not shown) for amplifying and demodulating received signals and may include one or more processors (not shown) for channel decoding and demultiplexing.

The mobile terminal 20 also includes a controller 44, a user interface 45, one or more memories 46, a encoder/decoder (codec) 49, a speaker 50 with corresponding amplifier 51 and a microphone 52 with a corresponding pre-amplifier 53.

The user interface 45 comprises a display 53 and a keypad 55. The display 53 is adapted for displaying images and video by, for instance, being larger and/or having greater resolution than a display of conventional mobile telephone and being capable of colour images. The mobile terminal 20 also includes a power source in the form of e.g. a rechargeable battery 56, to provide DC power.

The controller 44 manages operation of the mobile terminal 20 under the direction of software (not shown) stored in one of the memories 46. The controller 44 provides output signals for the display 53 and receives and processes inputs from the keypad 55.

The mobile terminal 20 may be modified by providing a single receiver adapted to receive signals from the DVB-T network 21 and the mobile telephone network and a transmitter adapted to transmit signals on the mobile telephone network (not shown). Alternatively, a single transceiver for both cormunications networks may be provided.

Referring to FIG. 6, part of the DVB-H receiver 42, is shown in more detail in the form of a functional block diagram. The receiver 42 is intermittently switched on to receive the time-sliced signal 28 from the first communications network 21. The signal 28 is amplified, demodulated, channel decoded and demultiplexed into elementary streams by an RF receiver section 60 and provided at an output 61. The RF receiver section 60 forms part of the DVB-H receiver 42, and may be separate from the other components of FIG. 6, which have more of a data processing role. The elementary streams include TS packets carrying application data bursts.

A TS filtering block 62 receives the TS stream from the RF receiver section 60. The TS filtering block 62 uses the PID value for the TS packets to filter them, and allows to pass through it only the TS packets belonging to the desired elementary streams. TS packets belonging to other elementary streams may be discarded or routed elsewhere as required.

A section parsing block 63 decapsulates the payload of the TS packets passed to it by the TS filtering block 62, and forms sections from these payloads. In doing this, it takes into account the possible adaptation field and Payload Unit Start Indicator (PUSI). The sections formed by this include IP datagrams.

A section decapsulation block 64 extracts from the result of the section parsing block 63 the real time parameters and the payload of each section. Using data in the table_id field of the sections to determine whether the section relates to MPE/MPE-FEC data or SI/PSI data, it sends the payload along with some real time parameters into whichever is appropriate of an MPE/MPE-FEC decoding block 65 and an SI/PSI table parsing block 66. All of the extracted real time parameters are fed also to a timeslicing control and status block 67. The timeslicing control and status block 67 analyses the real time parameters, and uses it to generate status data as appropriate. It also informs the MPE-FEC decoding block 65 when the maximum burst duration has elapsed. This information is needed by the MPE-FEC decoding block 65 to know to start decoding if the end of a burst is lost.

The MPE-FEC decoding block 65 writes the section payloads into an MPE-FEC frame according to address information (which is a real time parameter). It decodes the whole MPE-FEC frame row by row. This decoding is able to use erasure information, as described elsewhere in this specification, although the MPE-FEC decoding block 65 may be controlled instead to effect decoding without using erasure information as and when this is deemed appropriate. The MPE-FEC decoding block 65 includes some memory in which is stored erasure information and some memory in which is stored the data of the MPE-FEC frame. These memories may form part of the same memory device, as shown at 69 in the Figure, or they may be on different memory devices. As described below, the erasure information can be obtained from the section CRC-32 or, if the erroneous TS packets are passed forward, from the transport error indicator located in the header of the TS packet. The MPE-FEC decoding block 65 is controllable also not to use MPE-FEC error-correction decoding. When operating in this way, the MPE-FEC decoding block 65 functions merely as a time slicing buffer, storing one burst at a time.

Connected to an output of the MPE-FEC decoding block 65 is an IP parsing and filtering block 68. This receives whole MPE-FEC frames from the MPE-FEC decoding block 65. The IP parsing and filtering block 68 scans the corrected data areas in the frame and detects IP datagrams that were originally erroneous but were corrected by the decoder. It provides at its output only IP datagrams having a desired IP address.

Although in the above the SI/PSI data is not provided with MPE-FEC encoding, this is not essential. It may instead be delivered in a manner similar to that of the IP datagrams carrying application data.

Two embodiments of the invention will now be described. In each embodiment the same hardware, i.e. the hardware described above in relation to FIGS. 5 and 6 is used.

The first embodiment will now be described with reference to FIGS. 7 and 8 in particular. In FIG. 7, a simplified data frame 80 is shown. The data frame 80 is illustrated as having six columns of application and padding data and three columns of parity data. The number of rows included in the data frame 80 is not important to this embodiment.

A first datagram 81 is included in a first column 82 of the data frame 80. This is followed by a second datagram 83, which is also wholly within the first column. A third datagram 84 includes a portion in the first column and a portion also in a second column 85 of the data frame 80. A fourth datagram 86 completes the second column 85. A fifth datagram 87 occupies the entirety of a third column 88. A fourth column 89 includes sixth, seventh and eighth datagrams 90, 91 and 92. A ninth datagram 93 is included in a fifth column 94. The remainder of the fifth column 94 and the entirety of a sixth column 99 is comprised of zero padding. First, second and third parity data columns 95, 96 and 97 follow the end of the sixth application data column 99.

An erasure information table 98 includes one bit for each of the columns of the data frame 80. Thus, the size in bits of the erasure information table 98 is equal to the number of columns in the data frame 80. Although the data frame 80 is stored in the RS data buffet 67 and in the IP datagram buffer 66, the erasure information table 98 is stored in the RS decoder 69.

In this example, the second, seventh and eighth datagrams 83, 91 and 92 are received with errors and the other datagrams are received error-free. Furthermore, the second column of parity data 96 is received with errors. The other datagrams in the other columns of parity data received error-free.

Referring now to FIG. 8, an example of operation of the mobile terminal 20 is now described in detail. At step S1, the IP datagram buffer 65 and the RS data buffer 67 are filled with received data, constituting a data frame 80. This data is written into a table like that shown in FIG. 7 before decoding. The data frame 80 contains a number of elements equal to the number of rows in the data frame 80 multiplied by the number of columns therein. Each element comprises one byte of data. In this example, there are six columns of application and zero padding data and three columns of padding data, although it will be appreciated that this is merely an exampled selected to allow the invention to be easily described.

At step S2, the erasure information table 98 is initialised. This involves including in each of the elements of the erasure information table 98 data having a value indicating that data in a column of the data frame 80 corresponding to the element of the erasure information table is unreliable. Typically, the bit value “0” indicates unreliable data, although this is not essential. At step S3, the location of the zero padding is determined. This can utilise the table_boundary_flag described above, or can be carried out in any other way, e.g. by using information in the MPE section header. At step S4, elements of the erasure information table which corresponds to columns consisting of zero padding data are marked as being reliable. In FIG. 7, only the sixth element 108 the erasure information table 98 corresponds to a column, namely the sixth column 99, which includes only zero padding data.

At step S5, each of the datagrams is checked for errors e.g. by way of CRC data included in the corresponding MPE section. After step S5, the mobile terminal 20 knows which of the first to ninth datagrams 81, 83, 84, 86, 87, 90-93 includes errors, and which of those datagrams do not include errors. A step S6, elements of the erasure information table 98 corresponding to a column of the data frame 80 which includes the whole or a part of a datagram which is determined to include one or more errors is unchanged, i.e. it remains as indicating unreliable data. For each of the application data columns of the data frame 80 which include only datagrams not including any errors, the corresponding element of the erasure table 98 is changed. In the example illustrated in FIG. 7, the second and third columns 85, 88 and the fifth column 94 include datagrams which do not include any errors. Consequently, second, third and fifth elements, 100, 101 and 102 of the erasure information table 98 are marked as corresponding to reliable data in the data frame 80. Since the first and fourth columns 82 and 89 includes one or more datagrams including one or more errors, the first and fourth elements 103, 104 of the erasure information table 98 remain indicating unreliable data in the corresponding columns in the data frame 80.

At step S7, the columns of parity data 95, 96, 97 are checked e.g. using a CRC of the corresponding MPE-FEC section for errors. In the example of FIG. 7, this results in the first and third columns of parity data 95 and 97 passing the check, i.e. no errors are present in those columns, but the second column of parity data 96 fails that check since it includes one or mote errors. At step S8, the first, second and third parity data elements 105, 106, 107 of the erasure information table 98 are marked accordingly. In this case, the second element 106 is left unchanged, thereby indicating the presence of one or more errors in the corresponding parity data column 96 in the data frame 80, and the first and third elements 105, 107 are changed to show that the data in the corresponding parity data columns 95, 97 is reliable. At this point, each of the elements in the erasure information table 98 includes the appropriate erasure information.

At step S9, the erasure information table 98 is used to decode the data constituting the data frame 80 row by row. This is carried out by the RS decoder 69. This step is conventional except that the RS decoder 69 considers an element in a given row to include errors if the corresponding element in the erasure information table 98 indicates unreliable data. The result of this is that every element in a column is treated as including an error, even though there may be only one error present in that column. Furthermore, every element in a column can be treated as including an error if it includes part of a datagram in which an error is present, as determined by the CRC check on the MPE section including that datagram, even if the part of the datagram including an error actually is in an adjacent column. As such, the sensitivity of the RS decoding process implemented by the RS decoder 69 is compromised. However, the erasure information table 98 is required to include only a number of bits equal to the number of columns in the data frame 80, thereby saving a significant amount of memory in the mobile terminal 20. As long as the number of columns in the data frame 80 which are indicated as including unreliable data does not exceed the maximum number of errors that can be present whilst allowing the RS decoder 69 to correct satisfactorily errors in the data, then all the elements in the data frame 80 which include errors will necessarily be corrected. Since the use of erasure information enables more errors to be corrected than where erasure information is not used, the above described procedure can allow more errors to be corrected than might be possible if erasure information was not used, even though a very small amount of memory is needed to store the erasure information. The order of the steps may be different in other implementations.

Although the first embodiment is limited to a resolution of a single column, this is not necessary. Instead, the data frame may be divided into units of data which are larger than a single element but are smaller than a column. In this case, the erasure information table 98 includes one element for each of the units of data in the data frame 80. For example, each column could be divided into two, four or eight units of data, thereby increasing the size of the erasure information table 98 by two, four or eight respectively. However, in this case, improved error correction capabilities are provided, since an error in one unit of data in a column does not need to result in other units of data in that column being indicated as unreliable. Accordingly, more errors are able to be corrected by the RS decoder 69.

A second embodiment will now be described with reference to FIGS. 7, 9 and 10. The second embodiment instead of using an erasure information table like the table 98 of FIG. 7, includes an erasure information list of elements. One such erasure information list of elements is illustrated in FIG. 10.

Referring to FIG. 9, at step S1, the data frame 80 is filled with datagrams from the IP datagram buffer 65 and the RS data buffer 67, as described above in relation to FIG. 8. At step S2, a count is initialised at zero. At step S3, the length of the first datagram is determined. This can be carried out in any suitable way, for example, by using the starting address of the next IP datagram as signalled in the MPE section header. At step S4, the first datagram 81 is checked using the CRC data of the corresponding MPE section. At step S5, a first element 110 of the table 111 illustrated in FIG. 10 is filled. In a second column 113 of the list 111 and in a position corresponding to the first element 110, the count is placed. The count is the address of the beginning of the sequence of datagrams constituting the first element. In a third column 114 and in a position relating to the first element 110, information is placed indicating whether the first datagram 81 and any other datagrams included in that sequence are reliable or unreliable. In this example, an R is used to indicate that the datagram is reliable, and thus includes no errors. At step S6, the count is recalculated as being equal to the original count plus the length of the first datagram 81.

At step S7, the length of the next datagram is determined, in any suitable way. At step S8, this datagram is checked using its CRC. At step S9, it is determined whether the datagram has the same error status as the immediately preceding datagram. It will have the same status if both datagrams are reliable, or if both datagrams are unreliable. If, however, one is reliable and one is unreliable it will not have the same status. If it is determined at step S9 that the datagrams do not have the same error status, the next element in the erasure information list 111 is completed at step S10. The first time step S10 is reached, the next element is the second element 123. The element is completed by placing the value of the count in the address column 113, and by including in the erasure information column 114 an indication of the error status, which in this case is unreliable. Following step S10, the count is added to the length of the datagram, i.e. the count is added to the length of the second datagram in this instance, at step S11. Following step S11, it is determined at step S13 whether or not there are further datagrams in the data frame 80.

If it is determined at step S9 that the two datagrams have the same error status, at step S9, the count is added to the length of the datagram, and this value is then takes on the count value. Following step S12, it is determined at step S13 whether or not there are further datagrams in the dataframe 80. When step S13 reveals that there are further datagrams, the operations proceeds again to step S7 where the next datagram is processed.

The section length cannot be used to indicate the IP datagram length reliably if the MPE section contained errors, since there may be an error in the section length field. Accordingly, the above-described scheme for determining the start address for the column 113 is used when error free sections are received. If a section contains errors, the starting point of the unreliable data is known from the starting address and length of the previous field(s). For sections immediately following erroneous sections, the starting address is determined using the section header realtime parameters (in particular the address field thereof).

Once all the datagrams have been processed, step S13 replies with a “no” response. Here the procedure enters zero padding list elements at step S14 before entering parity data list data elements at step S15.

The effect of performance of the procedure of FIG. 9 on the data frame 80 of FIG. 7 is as follows. The first element 110 in the list 111 is filled with information which identifies the start address of the first datagram 81, i.e. address zero, and indicates in the erasure information column 114 that the data in the first datagram 81 is reliable. A fourth column 115 is shown in FIG. 10 although this column does not actually exist in the list 111. The fourth column 115 shows what datagrams correspond to the elements 110, 123 in the list 111. The second element 123 includes the start address of the second datagram 83, i.e. address 400, and in the erasure information column 114 indicates that this datagram is unreliable. A third element 116 includes a start address (800) of the third datagram 84, since the third datagram has a different error status to that of the second datagram 83. The erasure information column 114 indicates that this sequence of datagrams is reliable. Since the fourth, fifth and sixth datagrams 86, 87 and 90 have the same error status as that of the third datagram 84, i.e. all these datagrams are reliable, all these datagrams are included in the third element 116. Thus, the address in a fourth element 117 indicates the start address (3300) of the seventh datagram 91, which immediately follows the sixth datagram 90. Similarly, since the seventh and eighth datagrams 91,92 have the same error status, i.e. they are both unreliable, the address included in a fifth element 118 in the list 111 indicates the start address of the ninth datagram 93, i.e. address 4000. To simplify this example, it has been assumed that there are one thousand rows in the data frame 80, although it would be appreciated that this method could be applied to data frames having any number of rows

The zero padding list element entered at step S14 is labelled at 119 in FIG. 10. This indicates a start address of 4,600 which immediately follows the end of the ninth datagram 93. It also indicates an erasure information status of reliable, which is the same as the status of the immediately preceding sequence of datagrams, in this case the ninth datagram 93 listed in the fifth element 118. Instead of including separate elements 118 and 119 for the ninth datagram 93 and the zero padding, a single element could be used. However, the use of a separate element is preferred since it then makes it easier for the mobile terminal to distinguish between datagrams and zero padding. Indeed, the element relating to the zero padding may be included in a different list to the list 111, which in that case would be used only for pure application data.

Similarly, the parity data list elements entered at step S15 may be included in the list 111, or they may be included instead in a separate list (not shown). The list 111 includes elements 120, 121 and 122, which relate to the first; second and third parity data columns 95, 96 and 97 respectively. Had there been two adjacent parity data columns 95 to 97 having the same error status, these columns would have been included in a single element in the list 111.

Since elements in the list 111 relating to application data necessarily alternate between indicating reliable and unreliable data, it may be possible to omit the erasure information column 114. In this case, however, it will usually be necessary to indicate the error status of datagrams relating to the first element 110, so that the RS decoder 69 when using the erasure information knows whether the first datagram is reliable or unreliable.

In any case, the RS decoder 69 uses the information included in the list 111 to determine which elements in a row of data elements may include an error. It will be appreciated by a skilled person how this can be effected. Briefly, the RS decoder 69 when processing a row of data determines which data elements in that row fall within ranges indicated by the list 111 as including unreliable data, which is a relatively straightforward exercise.

It will be appreciated that the list 111 can require significantly less memory than would a conventional erasure information table as used in the prior art. Instead of requiring one bit for every element in the data frame 80, as occurs in the prior art, the list 111 needs to include one element for each sequence of consecutive datagrams which have the same error status. Although it may require some memory to store the address details in the second column 113, there inevitably will still be a memory saving where the datagrams are of sufficient length. Furthermore, if the datagrams are known to be integer multiples of a certain unit size, then the addresses stored in the address column 113 may be abbreviated in any suitable manner, resulting in a further saving of memory.

When the erasure information relating to application data is to be stored in the same list 111 as that relating to parity data, a further column (not shown) may be included. This column can include a 1 or a 0 indicating whether the corresponding element relates to application data or parity data. Alternatively, the list 111 could include a “table separator” element, which separates the elements relating to the application data from elements relating to parity data. In either case, the mobile terminal 20 can determine easily what elements relate to application data and what elements relate to parity data.

It will be appreciated that the second embodiment provides increased resolution compared to the first embodiment. In particular, the second embodiment identifies the datagrams which are unreliable by their start and end addresses (implicitly at least), whereas in the first embodiment, an error in one datagram necessarily results in all other datagrams sharing a column with that erroneous datagram being indicated as unreliable.

In both of the above embodiments, parity data columns can be punctured, by discarding them before transmission The number of punctured parity columns may vary dynamically between MPE-FEC frames and can be calculated. Puncturing decreases the overheads introduced by the parity data and thus decreases the needed bandwidth. However, the disadvantage of puncturing is an effectively weaker code rate. The opposite effect can be obtained by intentionally introducing zero-valued padding columns. This makes the code stronger but at the expense of bandwidth.

It will be appreciated that many modifications may be made to the embodiments hereinbefore described. For example, the mobile terminal 20 may be a Personal Distal Assistant (PDA) or other mobile terminal capable at least of receiving signals via the first communications network 21. The mobile terminal 20 may also be semi-fixed or semi-portable, such as a terminal cared in vehicle, such as a car.

Moreover, the invention has application in any forward error correction system, not just that described in the embodiments, and is applicable to rows and columns of different lengths.

Still further, although the processing has been described in respect of rows of a coding table, the table may be replaced by discrete ‘words’ which, if brought together, could form a coding table.

1. A forward error correction decoder, comprising at least one processor arranged:
to receive a data frame comprising plural multibit data elements able to be arranged into a table of columns and rows of data elements, the data frame including application data elements and parity data elements;
to check the data in the data frame for errors; and
to generate erasure information for each of plural units of data, each unit of data containing plural data elements, the erasure information indicating whether all the elements in the unit of data are error-free.

2. A decoder as claimed in claim 1, arranged to store the erasure information in an array, the array including an array element corresponding to each unit of data including application data.

3. A decoder as claimed in claim 2, the array additionally including an array element corresponding to each unit of data including parity data.

4. A decoder as claimed in claim 2, in which the data frame includes padding data elements, the array including an array element corresponding to each unit of padding data.

5. A decoder as claimed in claim 1, arranged to store the erasure information in a list of items, each item including an element address and an error indication, each item in the list identifying a boundary of a sequence of data units having the same error status.

6. A decoder as claimed in claim 5, in which each item in the list identifies a boundary of a sequence of data units having a different error status to each sequence which is adjacent the sequence.

7. A decoder as claimed in claim 5, arranged to store the erasure information in a first list for data units including application data, and a second list for data units including parity data.

8. A decoder as claimed in claim 1, in which the data frame comprises plural datagrams each comprising plural elements.

9. A decoder as claimed in claim 8, arranged to check whole datagrams for errors.

10. A decoder as claimed in claim 9, arranged to generate erasure information indicating an error in a unit of data if the unit of data includes at least part of a datagram which is determined to include at least one error.

11. A decoder as claimed in claim 1, in which each column of the data frame constitutes a single unit of data.

12. A decoder as claimed in claim 1, implemented as a Reed Solomon decoder.

13. A decoder as claimed in claim 1, in which the data frame is able to be arranged into 255 element columns, 191 of which are non-parity data element columns.

14. A receiver including a forward error correction decoder as claimed in claim 1.

15. A receiver as claimed in claim 14, implemented as a digital video broadcasting receiver.

16. A mobile terminal including a receiver as claimed in claim 14.

17. A method of operating a forward error correction decoder, the method comprising:
receiving a data frame comprising plural multibit data elements able to be arranged into a table of columns and rows of data elements, the data frame including application data elements and parity data elements;
checking the data in the data frame for errors; and
generating erasure information for each of plural units of data, each unit of data containing plural data elements, the erasure information indicating whether or not all the data elements in the unit of data are error-free.

18. A method as claimed in claim 17, arranged to store the erasure information in an array, the array including an array element corresponding to each unit of data including application data.

19. A method as claimed in claim 18, the array additionally including an array element corresponding to each unit of data including parity data.

20. A method as claimed in claim 18, in which the data frame includes padding data elements, the array including an array element corresponding to each unit of padding data.

21. A method as claimed in claim 17, in which the storing step comprises storing the erasure information in a list of items, each item including an element address and an error indication, each item in the list identifying a boundary of a sequence of data units having the same error status.

22. A method as claimed in claim 21, in which each item in the list identifies a boundary of a sequence of data units having a different error status to each sequence which is adjacent the sequence.

23. A method as claimed in claim 21, in which the storing step comprises storing the erasure information in a first list for data units including application data, and a second list for data units including parity data.

24. A method as claimed in claim 17, in which the data frame comprises plural datagrams each comprising plural elements.

25. A method as claimed in claim 24, in which the checking step comprises checking whole datagrams for errors.

26. A method as claimed in claim 25, in which the generating step comprises generating erasure information indicating an error in a unit of data if the unit of data includes at least part of a datagram which is determined to include at least one error.

27. A method as claimed in claim 17, in which each column of the data frame constitutes a single unit of data.
